(19) United States
(12) Patent Application Publication
(10) Pub. No.: US 2019/0321849 A1
(43) Pub. Date: Oct. 24, 2019

(54) FALLING-WATER MUFFLING DEVICE AND AN ATOMIZER

(71) Applicant: SHENZHEN NEARBYEXPRESS TECHNOLOGY DEVELOPMENT COMPANY LIMITED, Shenzhen (CN)

(72) Inventors: Guanghui ZU, Shenzhen (CN); Changbo XIN, Shenzhen (CN)

(73) Assignee: SHENZHEN NEARBYEXPRESS TECHNOLOGY DEVELOPMENT COMPANY LIMITED, Shenzhen (CN)

(21) Appl. No.: 16/439,758

(22) Filed: Jun. 13, 2019

Related U.S. Application Data
(63) Continuation of application No. PCT/CN2018/094079, filed on Jul. 2, 2018.

(30) Foreign Application Priority Data
Jul. 11, 2017 (CN) 201720833108.8

(51) Int. Cl. B05B 17/06; B05B 1/00

(52) U.S. Cl. CPC B05B 17/0653; B05B 17/0676; B05B 1/002

(57) ABSTRACT

A falling-water muffling device for an atomizer. The falling-water muffling device at least includes a falling-water receiving structure, wherein the falling-water receiving structure includes a sidewall and a water mist flow hole surrounded by the sidewall. The internal side of the sidewall forms a receiving surface configured to receive water droplets passing through the water mist flow hole, and a first air inlet is disposed on the sidewall.

### CROSS-REFERENCE TO RELATED APPLICATIONS

This application is a continuation of International Application No. PCT/CN2018/094079, filed on Jul. 2, 2018, which claims priority to Chinese Application No. 201720833108.8, filed on Jul. 11, 2017, the entire contents of each of which are incorporated herein by reference.

### TECHNICAL FIELD

The present disclosure relates to the field of atomizer technology, in particular, to a falling-water muffling device and an atomizer.

### BACKGROUND

Atomizers on the market, such as aromatherapy machines or humidifiers, mostly use a principle of ultrasonic atomization. An ultrasonic atomizer generates ultrasonic waves by high-frequency electronic oscillation which causes a high-frequency resonance of a ceramic atomizing sheet, and a cavitation is generated when the ultrasonic waves propagate in water. The atomizer pulverizes the water around a cavity into particles with a size of 1-3 μm to generate water mist on the water surface by a cavity explosion that occurs between the water and the air. However, water droplets will be caused to come out of the water surface when the ultrasonic atomizing sheet is in operation. Noise generated by the water droplets falling back onto the water surface may reduce user experience of users who are sensitive to sound.

### SUMMARY

The present disclosure provides a falling-water muffling device to solve a problem of large operating noise of an atomizer caused by falling water.

The present disclosure provides a falling-water muffling device for an atomizer. The falling-water muffling device may include a falling-water receiving structure, wherein the falling-water receiving structure may include a sidewall and a water mist flow hole surrounded by the sidewall. The internal side of the sidewall forms a receiving surface configured to receive water droplets passing through the water mist flow hole, and a first air inlet is disposed on the sidewall.

In an embodiment, an angle between the receiving surface and a horizontal plane may be α, and 0°<α<90°.

In an embodiment, the falling-water muffling device may further include a lower water shielding structure connected to a bottom of the sidewall of the falling-water receiving structure. The lower water shielding structure has a first through hole communicated with the water mist flow hole of the falling-water receiving structure.

In an embodiment, an angle between the internal side of the sidewall of the lower water shielding structure and a horizontal plane may be β, and α<β<90°.

In an embodiment, a second air inlet may be disposed on a sidewall of the lower water shielding structure.

In an embodiment, the falling-water muffling device may further include an upper water shielding structure connected to an end of the falling-water receiving structure remote from the lower water shielding structure. The upper water shielding structure has a second through hole communicated with the water mist flow hole of the falling-water receiving structure.

In an embodiment, an angle between the internal side of the sidewall of the upper water shielding structure and a horizontal plane may be γ, and α≤γ≤90°.

In an embodiment, a third air inlet may be disposed on the sidewall of the upper water shielding structure, and the third air inlet may be communicated with the first air inlet.

In an embodiment, a top end of the first air inlet may be higher than an uppermost mark of a water level scale of the atomizer.

In an embodiment, a top end of the third air inlet may be higher than an uppermost mark of a water level scale of the atomizer.

In an embodiment, a cross-sectional area of the falling-water receiving structure may taper from one end to the other end.

In an embodiment, the upper water shielding structure may be a polyhedral structure formed by a plurality of sidewalls of the upper water shielding structure. The lower water shielding structure may be a polyhedral structure formed by a plurality of sidewalls of the lower water shielding structure. The falling-water receiving structure may be a polyhedral structure formed by a plurality of sidewalls of the falling-water receiving structure.

In an embodiment, the water mist flow hole has a first opening and a second opening. The first through hole has a third opening and a fourth opening. The second through hole has a fifth opening and a sixth opening. A shape of a cross section of the first opening may be the same as a shape of a cross section of the fourth opening. The shape of a cross section of the second opening may be the same as the shape of a cross section of the fifth opening.

The present disclosure provides an atomizer to solve a problem of large operating noise of an atomizer caused by falling water.

The present disclosure provides an atomizer including the falling-water muffling device.

In an embodiment, the atomizer may further include a water tank and an atomizing sheet located at a bottom of the water tank, wherein the falling-water muffling device may be located in the water tank and directly above the atomizing sheet.

In an embodiment, a distance between a top end of the falling-water receiving structure and the atomizing sheet may be proportional to a power of the atomizing sheet.

In an embodiment, the atomizer may further include a base located below the water tank and a fan located inside the base.

In an embodiment, a count of the first air inlet(s) may be proportional to a power of the fan.

In an embodiment, an aperture diameter of the first air inlet may be proportional to the power of the fan.

The falling-water muffling device provided by the present disclosure can receive a large number of water droplets entering the falling-water muffling device to avoid a falling-water noise caused by the water droplets directly falling into the water. Meanwhile, the first air inlet disposed on the falling-water receiving structure can ensure an air circulation in the falling-water muffling device to allow the water mist to diffuse rapidly.

The falling-water muffling device disposed in the atomizer provided by the present disclosure can receive a large number of water droplets to avoid a large falling-water noise caused by water droplets directly falling into the water.

### BRIEF DESCRIPTION OF THE DRAWINGS

FIG. 1 is a side view of a first axial of a falling-water muffling device provided by an embodiment of the present disclosure;

FIG. 2 is a side view of a second axial of a falling-water muffling device in FIG. 1;

FIG. 3 is a front view of a falling-water muffling device in FIG. 1;

FIG. 4 is a top view of a falling-water muffling device in FIG. 1;

FIG. 5 is a front view of a falling-water muffling device provided by another embodiment of the present disclosure;

FIG. 6 is a front view of a falling-water muffling device provided by another embodiment of the present disclosure; and

FIG. 7 is a cross-sectional view of an atomizer provided by an embodiment of the present disclosure.

In the figures:

1, a base; 2, an upper cover; 20, an air outlet; 3, a falling-water muffling device; 31, an upper water shielding structure; 311, a third air inlet; 312, a second through hole; 32, a falling-water receiving structure; 320, a receiving surface; 321, a first air inlet; 322, a water mist flow hole; 33, a lower water shielding structure; 331, a second air inlet; 332, a first through hole; 4, a water tank; 5, an internal cover of a water tank; 6, an atomizing sheet; 7, a fan.

### DETAILED DESCRIPTION

In order to enable those skilled in the art to better understand the technical solution of the present disclosure, the technical solution of the present disclosure will be described below with reference to the accompanying drawings and the specific embodiments.

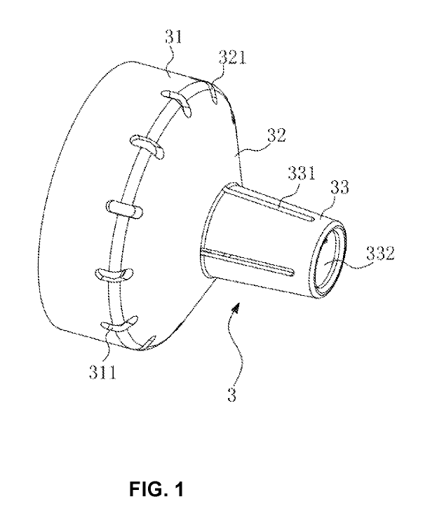

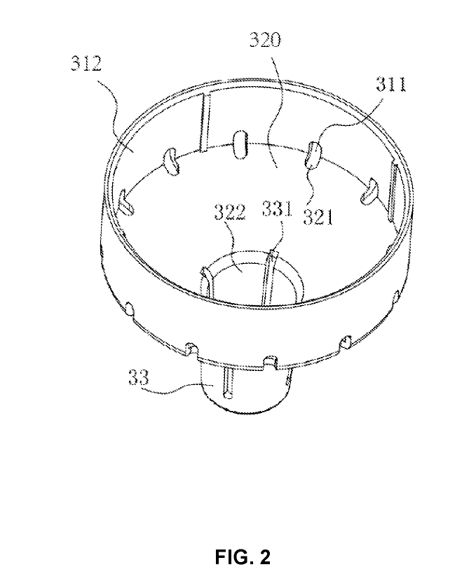

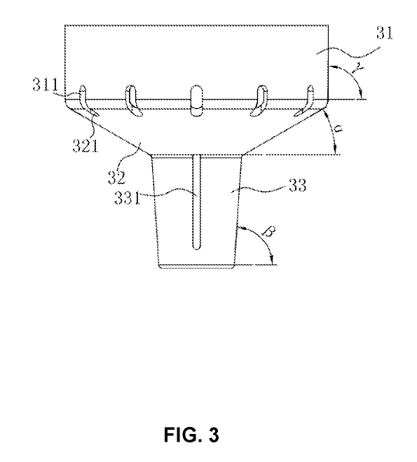

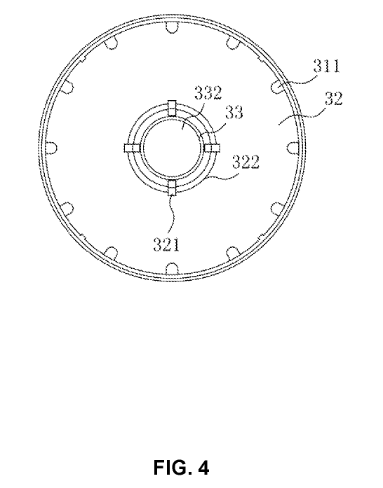

FIG. 1 is a side view of a first axial of a falling-water muffling device provided by an embodiment of the present disclosure; FIG. 2 is a side view of a second axial of a falling-water muffling device in FIG. 1; FIG. 3 is a front view of a falling-water muffling device in FIG. 1; FIG. 4 is a top view of a falling-water muffling device in FIG. 1. As shown in FIG. 1-FIG. 4, a falling-water muffling device 3 for an atomizer provided in this embodiment may at least include a falling-water receiving structure 32. The falling-water receiving structure 32 may include a sidewall and a water mist flow hole 322 formed by the sidewall. The internal side of the sidewall of the falling-water receiving structure 32 may form a receiving surface 320 configured to receive water droplets passing through the water mist flow hole 322 into the falling-water muffling device 3. The water mist flow hole 322 may have a first opening and a second opening.

In an embodiment, the receiving surface 320 may be disposed such that there is an angle between the receiving surface 320 and a horizontal plane. A value of the angle α between the receiving surface 320 and the horizontal plane may satisfy the range of 0°<α<90°. That is, the receiving surface 320 of the falling-water receiving structure 32 may be tilted relative to the horizontal plane, and a tilt angle may be less than 90°. In an embodiment, the falling-water receiving structure 32 may be considered as an upside down truncated pyramid or truncated cone with a tapered cross section. This structure may enable the water falling on the receiving surface 320 to slowly slide down along the receiving surface 320 under the gravity.

A first air inlet 321 may be disposed on the sidewall of the falling-water receiving structure 32. The water mist and water droplets generated by the atomization of the water may enter the falling-water muffling device 3 through the water mist flow hole 322. A purpose of setting the first air inlet 321 is to ensure an air circulation in the falling-water muffling device 3, so that the water mist can be blown out of the falling-water muffling device 3 and quickly diffused outside the atomizer.

The falling-water receiving structure 32 provided in this embodiment may receive a large number of water droplets to avoid a falling-water noise caused by a large number of water droplets directly falling into the water. Meanwhile, the first air inlet 321 disposed on the falling-water receiving structure 32 may ensure an air circulation in the falling-water muffling device 3 to allow the water mist to diffuse rapidly, and thus a good atomization effect may be achieved.

In an embodiment, the falling-water muffling device 3 may further include a lower water shielding structure 33. The lower water shielding structure 33 has a first through hole 332 formed by the sidewall of the lower water shielding structure 33. The first through hole 332 has a third opening and a fourth opening. The first through hole 332 and the water mist flow hole 322 may be communicated through the connection of the first opening of the water mist flow hole 322 and the fourth opening of the first through hole 332. The purpose of setting the lower water shielding structure 33 is to gather the water mist generated by the atomization in the atomizer through the lower water shielding structure 33, so that more water mist may enter the falling-water muffling device 3. An internal side of the sidewall of the lower water shielding structure 33 may be disposed at an angle with the horizontal plane. The angle between the internal side of the sidewall of the lower water shielding structure 33 and the horizontal plane may be β, and α<β<90°. The internal side of the sidewall of the lower water shielding structure 33 may receive water droplets of a lower height coming out of the water surface, and the water droplets may relatively rapidly slide down along the internal side of the sidewall of the lower water shielding structure 33.

In this embodiment, the falling-water muffling device 3 may further include an upper water shielding structure 31 connected to an end of the falling-water receiving structure 32 remote from the lower water shielding structure 33. The upper water shielding structure 31 has a second through hole 312 formed by the sidewall of the upper water shielding structure 31. The second through hole 312 has a fifth opening and a sixth opening. The fifth opening of the second through hole 312 may be communicated with the second opening of the water mist flow hole 322. The second through hole 312 may be connected with the water mist flow hole 322 of the falling-water receiving structure 32. The internal side of the sidewall of the upper water shielding structure 31 may be disposed such that there is an angle between the upper water shielding structure 31 and the horizontal plane. The angle between the internal side of the sidewall of the upper water shielding structure 31 and the horizontal plane may be γ, and α≤γ≤90°. The purpose of setting the upper water shielding structure 31 is to prevent the water droplets of a higher position coming out of the water surface from passing over the receiving surface 320 of the falling-water receiving structure 32 and leaving the falling-water muffling device 3, and guide the water droplets to slide down to the falling-water receiving structure 32.

The setting of the upper water shielding structure 31 and the lower water shielding structure 33 may maximize a blocking effect on the water droplet and ensure that the falling-water muffling device 3 can achieve an effect of noise reduction for the water droplets that fall from different heights.

In an embodiment, a second air inlet 331 may be disposed on the lower water shielding structure 33. The second air inlet 331 may be exposed to the water surface when a water level in the atomizer is low. The wind entering the second air inlet 331 may blow the atomized water out of the top of the falling-water muffling device 3. The second air inlet 331 may ensure an air circulation in the falling-water muffling device 3 when a water level is low, so that the water mist may be blown out of the falling-water muffling device 3 in time and diffused outside the atomizer and a good atomization effect can be achieved. It should be understood that the second air inlet 331 may be immersed by water when the water level in the atomizer is higher than the second air inlet 331. The wind entering the falling-water muffling device 3 from the first air inlet 321 may also blow the water mist out of the falling-water muffling device 3 in time.

The third water inlet 311 may be disposed on the sidewall of the upper water shielding structure 31 for speeding up the diffuse of the water mist inside the falling-water muffling device 3 to the outside of the atomizer. In this embodiment, the third air inlet 311 may be communicated with the first air inlet 321. The first air inlet 321 may be disposed on the top end of the sidewall of the falling-water receiving structure 32. The third air inlet 311 may be disposed on the bottom end of the upper water shielding structure 31. The communication of the third air inlet 311 and the first air inlet 321 may be equivalent to expansion of the aperture diameter of the air inlets, so that the falling-water muffling device 3 may be applied to the atomizer with a large amount of water mist.

In an embodiment, the top end of the first air inlet 321 may be higher than an uppermost mark of a water level scale of the atomizer if the third air inlet 311 is not disposed on the sidewall of the upper water shielding structure 31; and the top end of the third air inlet 311 may be higher than the uppermost mark of the water level scale of the atomizer if the third air inlet 311 is disposed on the sidewall of the upper water shielding structure 31. This design may ensure that the wind enters the falling-water muffling device 3 to achieve an air circulation in the falling-water muffling device 3.

In this embodiment, the upper water shielding structure 31 and the lower water shielding structure 33 may be both ring-shaped structures. Meanwhile, the falling-water receiving structure 32 may also be a ring-shaped structure and the shape of the cross section of the upper water shielding structure 31 and the lower water shielding structure 33 may be both annular. In other embodiments, the upper water shielding structure 31 and the lower water shielding structure 33 may be a polyhedral structure. For example, the cross sections of the upper water shielding structure 31 and the lower water shielding structure 33 may be a rectangular frame structure or a hexagonal frame structure. Meanwhile, the number count of sidewalls of the falling-water receiving structure 32 may be the same as the number count of sidewalls of the upper water shielding structure 31 and the lower water shielding structure 33. In an embodiment, a shape of a cross section of the first opening may be the same as a shape of a cross section of the fourth opening so that the water mist flow hole 322 may be seamlessly communicated with the first through hole 332. A shape of a cross section of the second opening may be the same as a shape of a cross section of the fifth opening so that the water mist flow hole 322 may be seamlessly communicated with the second through hole 312.

In this embodiment, a count of the second air inlet 331, the first air inlet 321, and the third air inlet 311 may be no less than two. The count of the second air inlet 331 may be less than the count of the first air inlets 321, and the count of the first air inlet 321 may be the same as the count of the third air inlets 311. The second air inlet 331 may be axially and evenly distributed on the sidewall of the lower water shielding structure 33. The first air inlet 321 may be axially and evenly distributed on the sidewall of the falling-water receiving structure 32. The third air inlet 311 may be axially and evenly distributed on the sidewall of the upper water shielding structure 31. It should be understood that since a circumference of the lower water shielding structure 33 is less than a circumference of the falling-water receiving structure 32, it is not needed to set many air inlets.

The falling-water muffling device in present disclosure may be applied to an atomizer using a principle of ultrasonic atomization. When the atomizing sheet atomizes the water in the atomizer, which causes water droplets, the water mist and the water droplets may enter the falling-water muffling device together. The water mist may be blown out of the falling-water muffling device by the wind. The water droplets from a lower height may be blocked by the lower water shielding structure 33, and slide down into the water along the internal side of the sidewall of the lower water shielding structure 33. The water droplets from a higher position may fall on the receiving surface 320 of the falling-water receiving structure 32 and slide down into the water along the receiving surface 320 and the internal side of the sidewall of the lower water shielding structure 33. The water droplets of the highest position may be blocked by the upper water shielding structure 31, and slide down into the water along the internal side of the sidewall of the upper water shielding structure 31, the falling-water receiving structure 32, and the internal side of the sidewall of the lower water shielding structure 33. Thus, the falling-water muffling device can not only ensure an efficiency of atomization of the atomizer, but also avoid a noise caused by the water droplets from different heights generated by the atomizing sheet falling directly into the water.

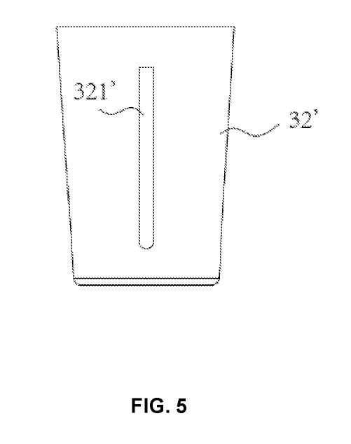

FIG. 5 is a front view of a falling-water muffling device provided by another embodiment of the present disclosure. In this embodiment, the falling-water muffling device only has a falling-water receiving structure 32′, and does not have the upper water shielding structure and the lower water shielding structure. The falling-water receiving structure 32′ may be an upside down truncated prism or truncated cone with a tapered cross section. The internal side of the sidewall of the falling-water receiving structure 32′ may be disposed such that there is an angle between the internal side of the sidewall of the falling-water receiving structure 32′ with the horizontal plane, and a value of the angle is greater than 0° and less than 90°. An air inlet 321′ with a strip-shaped structure may be disposed on the sidewall of the falling-water receiving structure 32′. The longitudinal direction of the air inlet may be disposed along the axial direction of the falling-water muffling device. In an embodiment, a top end of the air inlet 321′ may be higher than the uppermost mark of the water level scale of the atomizer.

The falling-water muffling device provided in this embodiment is simple in structure, easy to manufacture, and can receive a large number of water droplets sprayed upward from the atomizing sheet to avoid a noise caused by the large number of water droplets falling directly in the water. An air inlet 321′ disposed on the falling-water muffling device may also ensure air circulation in the falling-water muffling device to allow the water mist to diffuse in time.

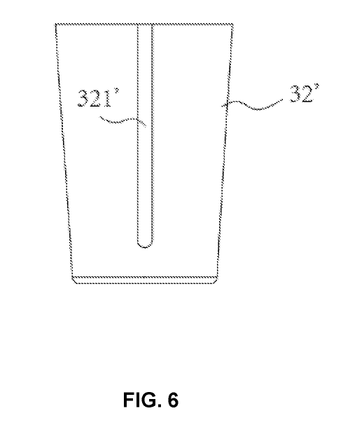

Referring to FIG. 6, in other embodiments, the top end of the air inlet 321′ may be flush with the top end of the falling-water muffling device. Thus, the uppermost mark of the water level scale of the atomizer may be marked at a higher position, i.e., the atomizer may contain more water.

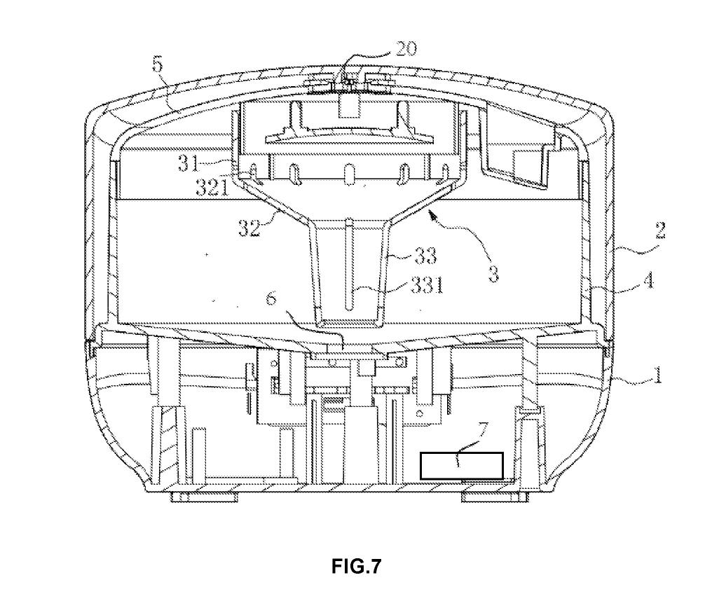

As shown in FIG. 7, the present disclosure also provides an atomizer. FIG. 7 is an atomizer with a falling-water muffling device provided by another embodiment of the present disclosure. The atomizer may include a falling-water muffling device 3, a base 1, an upper cover 2 matching the base 1, a water tank 4 located in a cavity formed by the base 1 and the upper cover 2, an internal cover 5 of the water tank, an atomizing sheet 6 disposed at a bottom of the water tank 4, and a fan 7 disposed in the base 1. The falling-water muffling device 3 may be located in a cavity formed by the water tank 4 and the internal cover 5 of the water tank.

The falling-water muffling device 3 may include an upper water shielding structure 31, a falling-water receiving structure 32, and a lower water shielding structure 33. The upper water shielding structure 31 may be engaged with the internal cover 5 of the water tank to fix the falling-water muffling device 3 below the internal cover 5 of the water tank. The lower water shielding structure 33 may be located directly above the atomizing sheet 6. A bottom of the lower water shielding structure 33 (i.e., the third opening of the first through hole 332) may be a water inlet. There is a gap between the water inlet and the atomizing sheet 6. Therefore, the water level in the falling-water muffling device 3 may be the same as the water level in the water tank 4.

In this embodiment, a distance between a top of the falling-water receiving structure 32 and the atomizing sheet 6 may be proportional to a power of the atomizing sheet 6. That is, the greater the power of the atomizing sheet 6, the farther the top of the falling-water receiving structure 32 is from the atomizing sheet 6 and the longer the lower water shielding structure 33. This is because the greater the power of the atomizing sheet 6, the mightier the water splashing during the oscillation, and the higher the water droplets splashing. Increasing the height of the position of the falling-water receiving structure 32 is more suitable for receiving more water droplets that fall from a high position.

In addition, since the water mist may condense into water droplets on the bottom surface of the internal cover 5 of the water tank. The falling-water receiving structure 32 may also be set to receive the water droplets dripping from the internal cover 5 of the water tank under the gravity to avoid a noise made by the dripping of the water droplets.

A third air inlet 311 may be disposed on the sidewall of the upper water shielding structure 31 of the falling-water muffling device 3. A first air inlet 321 may be disposed on the sidewall of the falling-water receiving structure 32. A second air inlet 331 may be disposed on the sidewall of the lower water shielding structure 33. An air outlet 20 may be disposed on the upper cover 2 of the atomizer. The air outlet 20 may be located above the internal cover 5 of the water tank and be communicated with a diffusion opening (i.e., the sixth opening of the second through hole 312) of the falling-water muffling device 3. There is a gap between the upper cover 2 and the internal cover 5 of the water tank so that a wind channel is formed.

During operation of the atomizer, the atomizing sheet 6 may act on the water in the water tank 4 to generate water mist above the atomizing sheet 6 and cause the water splash. The water mist and the water droplets may enter the falling-water muffling device 3 through the water inlet. The water droplets may fall on the upper water shielding structure 31, the falling-water receiving structure 32, or the lower water shielding structure 33, and finally slide down into the water along the internal side of the sidewall of the lower water shielding structure 33 under the gravity. The fan 7 located inside the base 1 may suck air outside into the base 1. The air may enter the water tank 4 through the wind channel, and then enter the falling-water muffling device 3 through the air inlet. The air may be blown to the diffusion opening, and finally blown from the air outlet 20 to bring the water mist outside the atomizer.

In this embodiment, a count of the air inlets may be proportional to a power of the fan. An aperture diameter of the air inlet may also be proportional to the power of the fan. In an embodiment, both the count and the aperture diameter of the third air inlet 321 of the upper water shielding structure 31, of the first air inlet 321 of the falling-water receiving structure 32, and of the second air inlet 331 of the lower water shielding structure 33 may be proportional to the power of the fan. When the power of the fan is relatively high, this design can match the power of the fan and generate a large amount of water mist, which is suitable for a high-power atomizer.

The atomizer provided by the present disclosure can eliminate a noise generated by the water droplets sprayed from the atomizing sheet or condensed by water mist that directly fall into the water while ensuring the atomization effect, thereby improving the user experience.

It should be noted that the basic principles and the main features of the present disclosure and the advantages of the present disclosure are shown and described above. It should be understood by those skilled in the art that the present disclosure is not limited by the above embodiments, and the above embodiments and descriptions are merely described to explain the principles of the present disclosure.

We claim:

1. A falling-water muffling device for an atomizer, comprising:
a falling-water receiving structure, wherein the falling-water receiving structure includes:
a sidewall;
a water mist flow hole formed by the sidewall, wherein an internal side of the sidewall forms a receiving surface configured to receive water droplets passing through the water mist flow hole; and
a first air inlet disposed on the sidewall.

2. The falling-water muffling device of claim 1, wherein an angle between the receiving surface and a horizontal plane is α, and 0°<α<90°.

3. The falling-water muffling device of claim 1, further comprising:
a lower water shielding structure connected to a bottom of the sidewall of the falling-water receiving structure, wherein the lower water shielding structure has a first through hole communicated with the water mist flow hole of the falling-water receiving structure.

4. The falling-water muffling device of claim 3, wherein an angle between the internal side of a sidewall of the lower water shielding structure and a horizontal plane is β, and α<β<90°.

5. The falling water muffling device of claim 4, wherein a second air inlet is disposed on the sidewall of the lower water shielding structure.

6. The falling-water muffling device of claim 3, further comprising:
an upper water shielding structure connected to an end of the falling-water receiving structure remote from the lower water shielding structure, wherein the upper water shielding structure has a second through hole communicated with the water mist flow hole of the falling-water receiving structure.

7. The falling-water muffling device of claim 6, wherein an angle between the internal side of a sidewall of the upper water shielding structure and a horizontal plane is γ, and α≤γ≤90°.

8. The falling-water muffling device of claim 7, wherein a third air inlet is disposed on the sidewall of the upper water shielding structure, and the third air inlet is communicated with the first air inlet.

9. The falling-water muffling device of any one of claims 1, wherein a top end of the first air inlet is higher than an uppermost mark of a water level scale of the atomizer.

10. The falling-water muffling device of claim 8, wherein a top end of the third air inlet is higher than an uppermost mark of a water level scale of the atomizer.

11. The falling-water muffling device of any one of claims 6, wherein a cross-sectional area of the upper water shielding structure taper from one end to the other end.

12. The falling-water muffling device of any one of claims 6, wherein:
the upper water shielding structure is a polyhedral structure formed by a plurality of sidewalls of the upper water shielding structure;
the lower water shielding structure is a polyhedral structure formed by a plurality of sidewalls of the lower water shielding structure; and
the falling-water receiving structure is a polyhedral structure formed by a plurality of sidewalls of the falling-water receiving structure.

13. The falling-water muffling device of claim 6, wherein:
the water mist flow hole has a first opening and a second opening;
the first through hole has a third opening and a fourth opening; and
the second through hole has a fifth opening and a sixth opening, wherein
a shape of a cross section of the first opening is the same as a shape of a cross section of the fourth opening, and
a shape of a cross section of the second opening is the same as a shape of a cross section of the fifth opening.

14. An atomizer, comprising a falling-water muffling device, wherein the falling-water muffling device includes:
a falling-water receiving structure, wherein the falling-water receiving structure includes:
a sidewall;
a water mist flow hole formed by the sidewall, wherein an internal side of the sidewall forms a receiving surface configured to receive water droplets passing through the water mist flow hole; and
a first air inlet disposed on the sidewall.

15. The atomizer of claim 14, further comprising:
a water tank; and
an atomizing sheet located at a bottom of the water tank, wherein the falling-water muffling device is located in the water tank and directly above the atomizing sheet.

16. The atomizer of claim 15, wherein a distance between a top end of the falling water structure and the atomizing sheet is proportional to a power of the atomizing sheet.

17. The atomizer of claim 15, further comprising:
a base located below the water tank; and
a fan located inside the base.

18. The atomizer of claim 17, wherein a count of the first air inlet(s) is proportional to a power of the fan.

19. The atomizer of claim 17, wherein an aperture diameter of the first air inlet is proportional to the power of the fan.

20. The atomizer of claim 14, wherein the falling-water muffling device further includes a lower water shielding structure connected to a bottom of the sidewall of the falling-water receiving structure, the lower water shielding structure having a first through hole communicated with the water mist flow hole of the falling-water receiving structure.
